(19) United States
(12) Patent Application Publication
(10) Pub. No.: US 2020/0005551 A1
(43) Pub. Date: Jan. 2, 2020

(54) DISPLAY CONTROL METHOD AND DISPLAY CONTROL APPARATUS

(71) Applicant: FUJITSU LIMITED, Kawasaki-shi (JP)

(72) Inventors: Tomoyuki Baba, Narashino (JP); Atsunori Moteki, Chofu (JP); Ayu Karasudani, Yamato (JP); Tomohiro Aoyagi, Toshima (JP); Takuya Kozaki, Yokohama (JP); Masahiro Kataoka, Kamakura (JP)

(73) Assignee: FUJITSU LIMITED, Kawasaki-shi (JP)

(21) Appl. No.: 16/448,036

(22) Filed: Jun. 21, 2019

(30) Foreign Application Priority Data
Jun. 27, 2018 (JP) 2018-121732

(51) Int. Cl. G06T 19/20; G06T 7/00; G06T 7/12; G06T 17/00

(52) U.S. Cl. CPC G06T 19/20; G06T 7/001; G06T 2207/30164; G06T 17/00; G06T 7/12

(57) ABSTRACT

A display control method includes, displaying a first plurality of edge lines extracted from an image that includes a manufactured article, accepting designation for a second plurality of edge lines selected from the displayed first plurality of edge lines, identifying pairs each of which includes an edge line of the second plurality of edge lines and a line of a plurality of lines corresponding to the edge line, the plurality of lines being included in a three-dimensional model, determining a specific display posture of the three-dimensional model such that a positional relation between a first edge line and a first line included in a first pair satisfies a condition and a position of a second edge line and a position of a second line included in a second pair correspond to each other, and superimposing, in accordance with the specific display posture, the three-dimensional model on the image.

### CROSS-REFERENCE TO RELATED APPLICATION

This application is based upon and claims the benefit of priority of the prior Japanese Patent Application No. 2018-121732, filed on Jun. 27, 2018, the entire contents of which are incorporated herein by reference.

### FIELD

The embodiment relates to a display control technique.

### BACKGROUND

There is a three-dimensional superimposition technique of superimposition-displaying three-dimensional computer aided design (CAD) data in accordance with design data of a manufactured article on an image obtained by shooting the manufactured article using an augmented reality technique (an AR technique).

According to the three-dimensional superimposition technique, a gap may be checked between the manufactured article depicted in a shot image and the three-dimensional CAD data. A worker may therefore diagnose (superimposition-diagnose) whether or not the manufactured article is manufactured in accordance with the three-dimensional CAD data.

A related technique is disclosed in, for example, Japanese Laid-open Patent Publication No. 2017-91078.

### SUMMARY

According to an aspect of the embodiment, a display control method includes, displaying a first plurality of edge lines extracted from an image that includes a manufactured article, accepting designation for a second plurality of edge lines selected from the displayed first plurality of edge lines, identifying pairs each of which includes an edge line of the second plurality of edge lines and a line of a plurality of lines corresponding to the edge line, the plurality of lines being included in a three-dimensional model, determining a specific display posture of the three-dimensional model such that a positional relation between a first edge line and a first line included in a first pair satisfies a condition and a position of a second edge line and a position of a second line included in a second pair correspond to each other, and superimposing, in accordance with the specific display posture, the three-dimensional model on the image.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a first diagram depicting an application example of a three-dimensional superimposition technique.

FIG. 2 is a diagram depicting an example of a hardware configuration of an information processing apparatus.

FIG. 3 is a diagram depicting an example of a functional configuration of an information processing apparatus.

FIG. 4 is a flowchart depicting a flow of a display control process executed by an information processing apparatus according to a first embodiment.

FIG. 5 is a diagram depicting exemplary screens for a three-dimensional CAD data obtaining process.

FIG. 6 is a diagram depicting exemplary screens for a shot image data obtaining process.

FIG. 7 is a diagram depicting exemplary screens for processes from a display process to a superimposition data display process.

FIG. 8 is a first flowchart depicting details of a superimposition process.

FIG. 9 is a flowchart depicting a flow of a display control process executed by an information processing apparatus according to a second embodiment.

FIG. 10 is a diagram depicting exemplary screens for processes from a display process to a difference area display process.

FIG. 11 is a first diagram depicting exemplary screens for a difference area display process.

FIG. 12 is a second diagram depicting an exemplary screen for a difference area display process.

FIG. 13 is a second flowchart depicting details of a superimposition process.

FIG. 14 is a second diagram depicting an application example of a three-dimensional superimposition technique.

FIGS. 15A, 15B, and 15C are each a schematic diagram for explaining a relation between a superimposition display and gap information.

### DESCRIPTION OF EMBODIMENT

With the three-dimensional superimposition technique, the positions for gaps to be generated differ depending on the superimposition method. For example, the positions for the gaps to be generated differ between the case where the superimposition is executed for a manufactured article depicted in a shot image such that the total of the gaps becomes its minimum and the case where the superimposition is executed such that one end of the manufactured article depicted in the shot image and the corresponding one end in the three-dimensional CAD data match with each other. With the conventional technique, a worker may learn the presence or absence of any gap as “gap information” while the worker cannot learn also the causative points of the gaps such as which portions of the manufactured article the gaps are generated being originated from defects in.

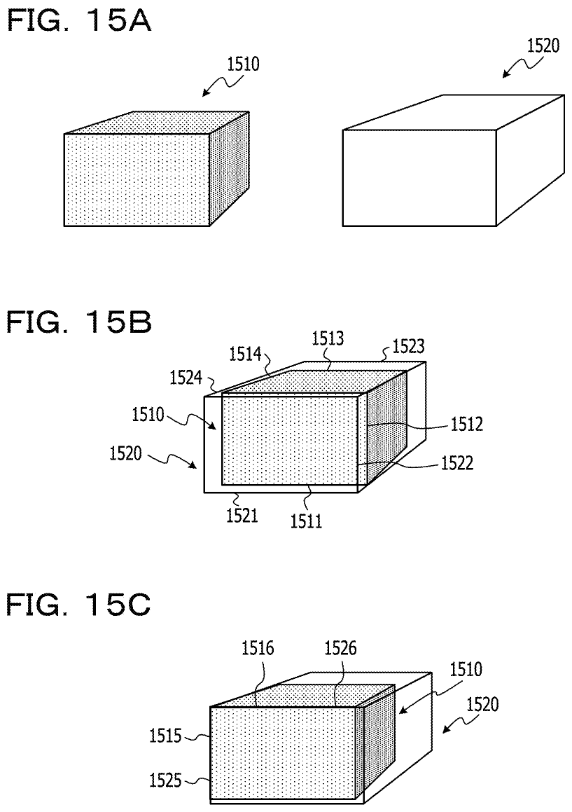

The relation between the superimposition display executed by an information processing apparatus according to each of the following embodiments and the gap information will briefly be described first with reference to FIGS. 15A, 15B, and 15C. FIGS. 15A, 15B, and 15C are each a schematic diagram for explaining the relation between the superimposition display and the gap information. The “superimposition display” as used herein refers to superimposing a three-dimensional model in accordance with the design data (for example, three-dimensional CAD data) of a manufactured article on a shot image obtained by shooting the manufactured article, to be displayed therewith.

As depicted in FIG. 15A, in the case where three-dimensional CAD data 1520 of a manufactured article 1510 is superimposed on the manufactured article 1510 included in a shot image, to be displayed therewith, any optional superimposition method is admitted. Of the admitted methods, FIG. 15B depicts a superimposition method of superimposition-displaying designating four pairs from plural edge line pairs including plural edge lines extracted from the manufactured article 1510 and plural ridge lines included in the three-dimensional CAD data 1520 of the manufactured article (hereinafter, referred to each as “edge line”).

For example, FIG. 15B depicts the superimposition method of designating, as the four pairs of edge lines, an edge line 1511 of the manufactured article 1510 included in the shot image and an edge line 1521 in the three-dimensional CAD data 1520, ;an edge line 1512 of the manufactured article 1510 included in the shot image and an edge line 1522 in the three-dimensional CAD data 1520, ;an edge line 1513 of the manufactured article 1510 included in the shot image and an edge line 1523 in the three-dimensional CAD data 1520, and; an edge line 1514 of the manufactured article 1510 included in the shot image and an edge line 1524 in the three-dimensional CAD data 1520, and executing the superimposition display such that the total of the gap amounts of the designated four pairs becomes its minimum.

In the case of the superimposition method depicted in FIG. 15B, a gap is generated in the edge line of all the pairs between the manufactured article 1510 included in the shot image and the three-dimensional CAD data 1520.

The worker performing a superimposition diagnosis may therefore easily learn the fact that gaps are generated between the manufactured article 1510 and the three-dimensional CAD data 1520 as the gap information. The worker however cannot learn also the causative points of the gaps such as which portions of the manufactured article 1510 the gaps are generated being originated from defects in.

In contrast, the information processing apparatus according to each of the following embodiments designates a reference line (one of the edge lines or the ridge lines) or a reference point (a point on an edge line or a ridge line) used by the manufacturer when the manufactured article 1510 is produced and executes the superimposition display such that the reference lines (or the reference points) match with each other. FIG. 15C depicts an superimposition method of designating reference lines 1515 and 1516 from the edge lines of the manufactured article 1510 included in the shot image, designating reference lines 1525 and 1526 from the edge lines of the three-dimensional CAD data 1520, and executing the superimposition display such that these two match with each other.

As above, in the case where the superimposition display is executed such that the reference lines match with each other, the worker may learn presence or absence of gaps and the causative points of the gaps as the gap information by comparing the edge lines of the three-dimensional CAD data 1520 to the edge lines of the manufactured article 1510 other than the reference lines and the reference lines.

For example, according to the information processing apparatus according to the following embodiments, the precision may be improved for the display of the gaps from the design data of the manufactured article generated due to the manufacture of the manufactured article.

The embodiments will be described below with reference to accompanying drawings. Of the following embodiments, in the first embodiment, the case will be described where given number (=one pair) of pairs of reference lines is designated. In the second embodiment, the case will be described where given number (=two pairs) of pairs of reference lines is designated. In the specification and the drawings for the following embodiments, constituent elements having the substantially same functions and the same configurations are given the same reference numeral and will not again be described.

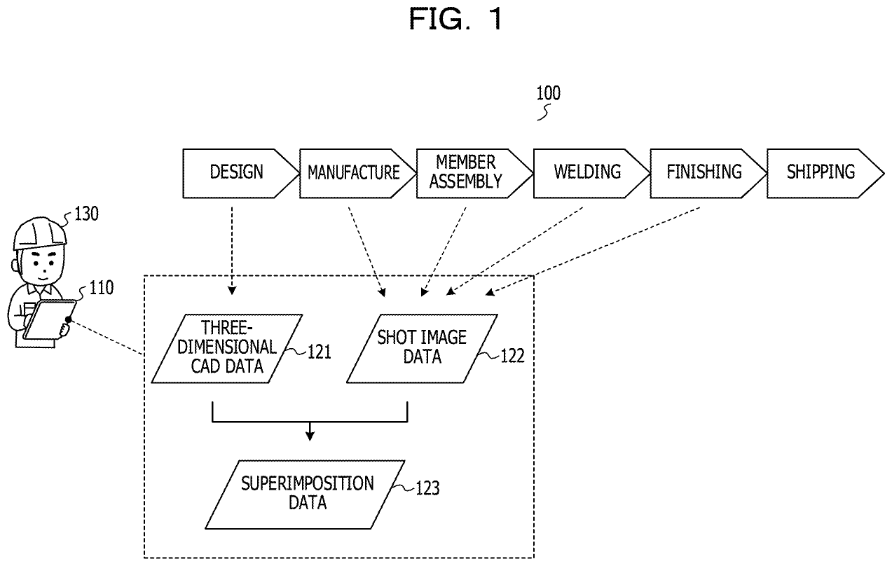

An application example of the three-dimensional superimposition technique sill be first described. FIG. 1 is a first diagram depicting an application example of the three-dimensional superimposition technique. In FIG. 1, a process 100 represents common processes from the manufacture of a product in a manufacturer to the shipping thereof.

As depicted in FIG. 1, the manufacturer first executes designing of the product in a design process and produces the three-dimensional CAD data. The manufacturer next manufactures members that constitute the product based on the three-dimensional CAD data at a manufacture process and assembles the manufactured members at a member assembly process. The manufacturer next welds the assembly members to each other at a welding process and executes a finishing process at a finishing process to complete the product. The manufacturer thereafter ships the completed product at a shipping process.

An information processing apparatus (for example, a tablet terminal) 110 to which the three-dimensional superimposition technique is applied obtains shot image data 122 shot at each of the processes, and displays superimposition data 123 produced by superimposing the corresponding three-dimensional CAD data 121 thereon, to a worker 130.

The worker 130 may thereby diagnose whether or not the manufactured article at each of the processes matches with the content of the design. The “manufactured article at each of the processes” refers to, for example, each member constituting the product for the manufacture process and an assembly member for the member assembly process. The manufactured article thereat refers to a shape-forming member obtained by welding the assembly members to each other for the welding process, and the product before its shipping for the finishing process.

At any one of the processes, the information processing apparatus 110 may produce the superimpose data 123 by reading the corresponding three-dimensional CAD data 121, and may display the superimposition data 123 to the worker 130.

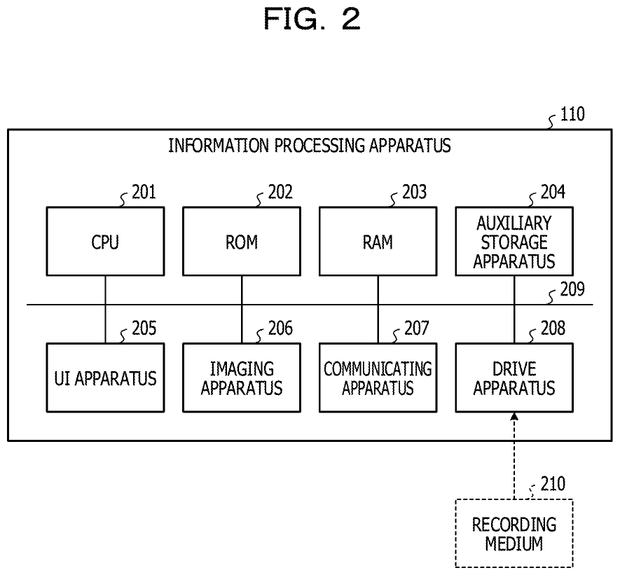

A hardware configuration of the information processing apparatus 110 will next be described. FIG. 2 is a diagram depicting an example of the hardware configuration of the information processing apparatus. As depicted in FIG. 2, the information processing apparatus 110 includes a central processing unit (CPU) 201, a read only memory (ROM) 202, and a random access memory (RAM) 203. The CPU 201, the ROM 202, and the RAM 203 form a what-is-called a computer.

The information processing apparatus 110 includes an auxiliary storage apparatus 204, a user interface (UI) apparatus 205, an imaging apparatus 206, a communicating apparatus 207, and a drive apparatus 208. The pieces of the hardware of the information processing apparatus 110 are coupled to each other through a bus 209.

The CPU 201 is a device that executes various types of programs (such as, for example, a display control program described later) installed in the auxiliary storage apparatus 204.

The ROM 202 is a non-volatile memory. The ROM 202 functions as a main storage device that stores therein various types of program, various types of data, and the like that are desirable for the CPU 201 to execute the various types of program installed in the auxiliary storage apparatus 204. For example, the ROM 202 functions as the main storage device that stores therein boot programs such as a basic input/output system (BIOS) and an extensible firmware interface (EFI).

The RAM 203 is a volatile memory such as a dynamic random access memory (DRAM) a static random access memory (SRAM), or the like. The RAM 203 functions as a main storage device that presents a work area expanded when the CPU 201 executes the various types of program installed in the auxiliary storage apparatus 204.

The auxiliary storage apparatus 204 is an auxiliary storage device that stores therein the various types of program, and the information used when each of the various types of programs is executed. For example, a three-dimensional CAD data storing part (described later) storing therein the three-dimensional CAD data 121 is realized by the auxiliary storage apparatus 204.

The UI apparatus 205 is a user interface device that presents to the worker 130 a display screen to display therein the three-dimensional CAD data 121, the shot image data 122, and the superimposition data 123, and that accepts various types of instruction through the display screen.

The imaging apparatus 206 is a shooting device that shoots the manufactured article at each of the processes and that produces the shot image data 122 for the process. The communicating apparatus 207 is a communicating device that couples the information processing apparatus to the network and that executes communication therewith.

The drive apparatus 208 is a device to set a recording medium 210. The “recording medium 210” as used herein includes a medium that optically, electrically, or magnetically records thereon information like the one such as a compact disc read only memory (CD-ROM), a flexible disc, a magnetooptical disc, or the like. The recording medium 210 may include a semiconductor memory or the like that electrically records thereon information like the one such as a ROM, a flash memory, or the like.

The various types of program installed in the auxiliary storage apparatus 204 are installed by, for example, the fact that the distributed recording medium 210 is set in the drive apparatus 208 and the various types of programs recorded on the recording medium 210 are read by the drive apparatus 208. Otherwise, the various types of program installed in the auxiliary storage apparatus 204 may be installed by being downloaded by the network through the communicating apparatus 207.

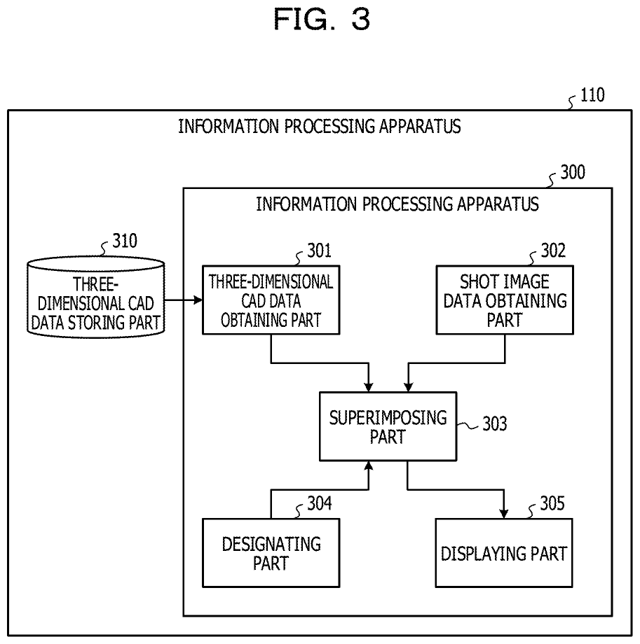

The functional configuration of the information processing apparatus 110 will next be described. FIG. 3 is a diagram depicting an example of a functional configuration of an information processing apparatus. As described above, the information processing apparatus 110 includes the display control program installed therein and the information processing apparatus 110 functions as a display control part 300 by executing the display control program including a plurality of instructions.

The display control part 300 includes a three-dimensional CAD data obtaining part 301, a shot image data obtaining part 302, a superimposing part 303, a designating part 304, and a displaying part 305.

The three-dimensional CAD data obtaining part 301 reads the three-dimensional CAD data 121 designated by the worker 130 from a three-dimensional CAD data storing part 310 that stores therein the three-dimensional CAD data 121. The three-dimensional CAD data obtaining part 301 identifies the edge lines in the read three-dimensional CAD data 121. The three-dimensional CAD data obtaining part 301 notifies the superimposing part 303 of the read three-dimensional CAD data (that includes the information relating to the identified edge lines).

The shot image data obtaining part 302 shoots the manufactured article at each of the processes by controlling the imaging apparatus 206 based on an instruction of the worker 130 and thereby obtains the shot image data 122. The shot image data obtaining part 302 extracts the edge lines of the manufactured article included in the shot image data 122. The shot image data obtaining part 302 notifies the superimposing part 303 of the obtained shot image data 122 (that includes the information relating to the extracted edge lines).

The superimposing part 303 is an example of an identifying part. The superimposing part 303 notifies the displaying part 305 of the notified three-dimensional CAD data 121 and the notified shot image data 122 and thereby displays the three-dimensional CAD data 121 and the shot image data 122 to the worker 130 through the UI apparatus 205.

The superimposing part 303 accepts a notice relating to the designation of the reference lines and designation of the edge lines other than the reference lines from the designating part 304 in response to its displaying of the three-dimensional CAD data 121 and the shot image data 122 through the UI apparatus 205. The “reference line” refers to the edge line to be the criterion, that is used by the manufacturer when the manufactured article is manufactured at each of the processes.

The superimposing part 303 identifies the posture of the three-dimensional CAD data 121 on the basis of the designation for the reference lines and the designation for the edge lines other than the reference lines. The “posture of the three-dimensional CAD data 121” refers to the position and the angle of the three-dimensional CAD data 121.

The superimposing part 303 produces the superimposition data 123 by superimposing the three-dimensional CAD data 121 whose posture is identified, on the shot image data 122. The superimposing part 303 notifies the displaying part 305 of the produced superimposition data 123.

The designating part 304 notifies the superimposing part 303 in the case where the worker 130 executes the designation for the reference lines and the designation for the edge lines other than the reference lines in response to the fact that the three-dimensional CAD data 121 and the shot image data 122 are displayed through the UI apparatus 205.

The displaying part 305 is an example of a displaying part or a superimposition-displaying part. The displaying part 305 produces a display screen to display therein the three-dimensional CAD data 121, the shot image data 122, and the superimposition data 123 that are notified of from the superimposing part 303 and displays these pieces of data therein. It is assumed that the display screen produced by the displaying part 305 includes operation buttons to input the designation for the reference lines and the designation for the edge lines other than the reference lines.

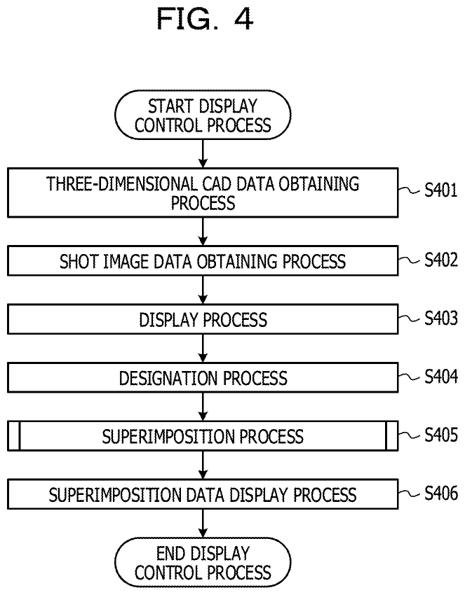

The flow of the display control process executed by the display control part 300 of the information processing apparatus 110 according to the first embodiment will be described. FIG. 4 is a flowchart depicting a flow of a display control process executed by an information processing apparatus according to the first embodiment. The display control process depicted in FIG. 4 is started by the fact that the display control program is started up by the information processing apparatus 110.

At step S401, the three-dimensional CAD data obtaining part 301 executes a three-dimensional CAD data obtaining process, obtains the three-dimensional CAD data 121, and identifies the edge lines.

At step S402, the shot image data obtaining part 402 executes a shot image data obtaining process, obtains the shot image data 122, and extracts the edge lines.

At step S403, the superimposing part 303 and the displaying part 305 execute the displaying process and display a display screen to display therein the three-dimensional CAD data 121 and the shot image data 122.

At step S404, the designating part 304 executes a designation process and accepts the designation for the reference lines and the designation for the edge lines other than the reference lines that are input thereinto through the display screen.

At step S405, the superimposing part 303 executes a superimposition process, identifies the posture of the three-dimensional CAD data 121, superimposes the three-dimensional CAD data 121 on the shot image data 122, and thereby produces the superimposition data 123.

At step S406, the displaying part 305 executes a superimposition data display process and displays the produced superimposition data 123.

Specific example of each of the processes (step S401 to S406) of the display control process (FIG. 4) will next be described.

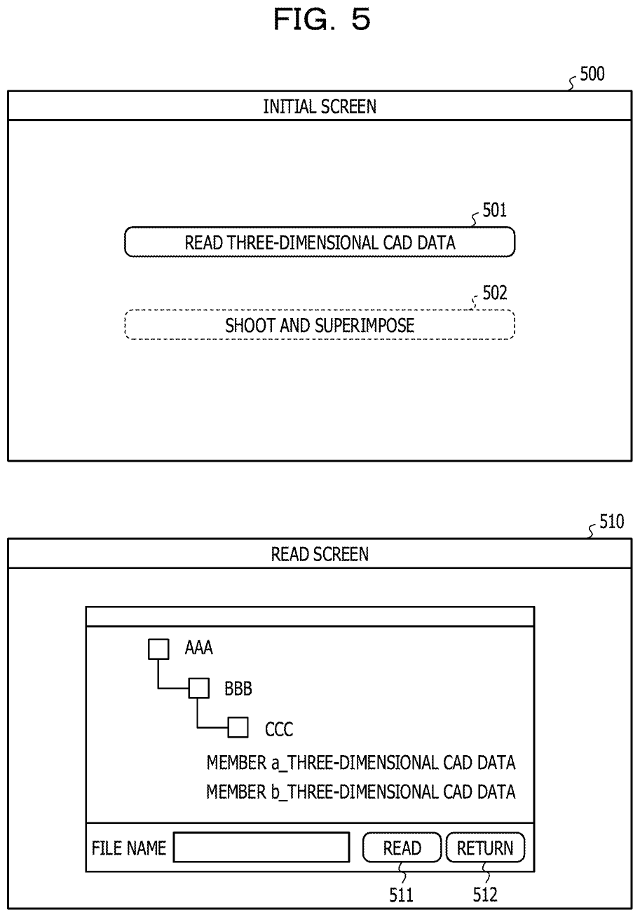

Exemplary screens of the display screen for the time when the three-dimensional CAD data obtaining process is executed will first be described as a specific example of the three-dimensional CAD data obtaining process (step S401). FIG. 5 is a diagram depicting exemplary screens of the three-dimensional CAD data obtaining process.

The display control process (FIG. 4) is started up and an initial screen 500 is thereby displayed on the information processing apparatus 110. As depicted in FIG. 5, the initial screen 500 includes a “read three-dimensional CAD data” button 501 and a “shoot and superimpose” button 502. In the initial screen 500 at the time when the reading of the three-dimensional CAD data 121 is not yet executed, the “shoot and superimpose” button 502 is displayed to be not selectable.

In the initial screen 500, when the worker 130 selects the “read three-dimensional CAD data” button 501, the three-dimensional CAD data obtaining part 301 displays a read screen 510 and accepts the designation for the three-dimensional CAD data 121 by the worker 301.

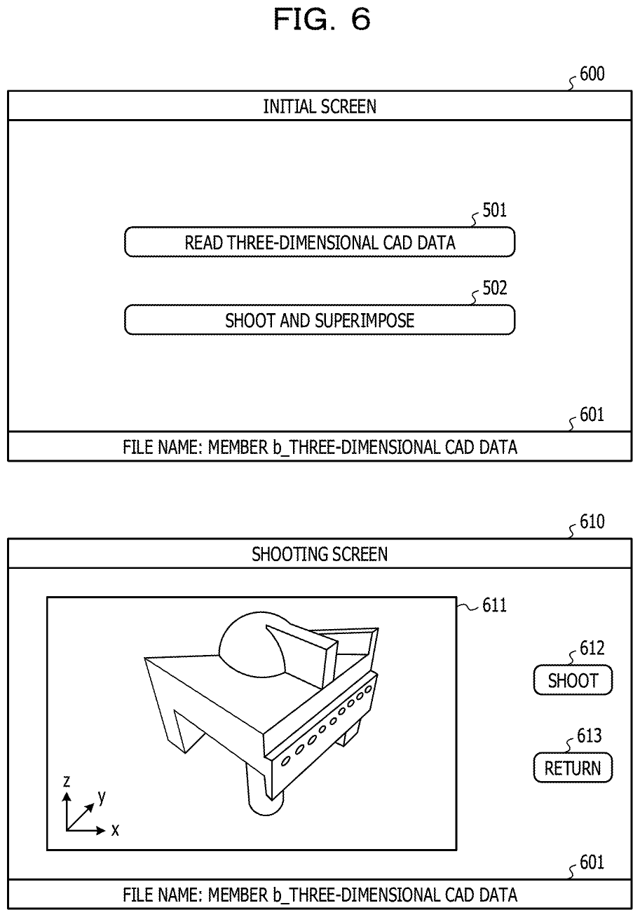

When the three-dimensional CAD data 121 is designated and the “read” button 511 is pressed down in the read screen 510, the three-dimensional CAD data obtaining part 301 reads the designated three-dimensional CAD data 121 from the three-dimensional CAD data storing part 310. The display screen thereafter returns from the read screen 510 to an initial screen 600 (FIG. 6).

On the other hand, when a “return” button 512 is pressed down in the read screen 510, the three-dimensional CAD data obtaining part 301 does not read the three-dimensional CAD data 121 and returns from the read screen 510 to the initial screen 500 (FIG. 5).

Exemplary screens of the display screen at the time when the shot image data obtaining process is executed will next be described as a specific example of the shot image data obtaining process (step S402). FIG. 6 is a diagram depicting exemplary screens for the shot image data obtaining process.

As described above, when the three-dimensional CAD data obtaining part 301 reads the three-dimensional CAD data 121, the display screen returns to the initial screen 600 in FIG. 6. As depicted in FIG. 6, the initial screen 600 includes the “read three-dimensional CAD data” button 501 and the “shoot and superimpose” button 502. Because the reading of the three-dimensional CAD data 121 is already executed at this time point, the “shoot and superimpose” button 502 is displayed to be selectable in the initial screen 600. The file name of the three-dimensional CAD data 121 that is read, is displayed in a file name display column 601.

When the worker 130 selects the “shoot and superimpose” button 502 in the initial screen 600, the shot image data obtaining part 302 displays a shooting screen 610. The shooting screen 610 includes a monitor 611 that displays the manufactured article, a “shooting” button 612, and a “return” button 613.

The monitor 611 displays thereon the manufactured article that is currently shot by the imaging apparatus 206. It is assumed that the monitor 611 has, for example, the coordinate axes (an x-axis, a y-axis, and a z-axis) of the world coordinate system defined therein. The “shoot” button 612 accepts an instruction of shooting for the manufactured article displayed on the monitor 611.

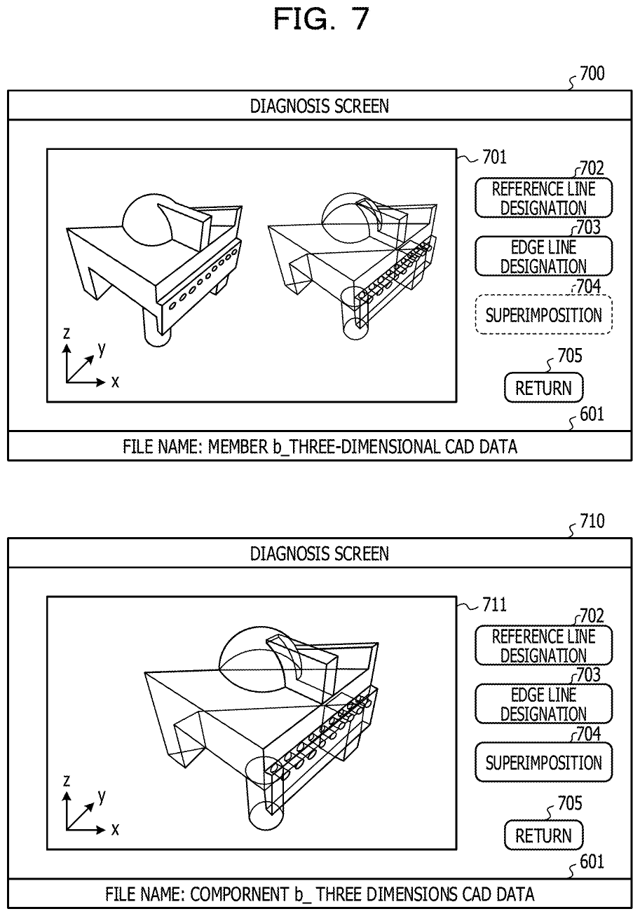

When the “shoot” button 612 is pressed down in the shooting screen 610, the shot image data obtaining part 302 obtains the shot image data 122 for the manufactured article that is currently shot and advances to a diagnosis screen 700 (FIG. 7).

On the other hand, when the “return” button 613 is pressed down in the shooting screen 610, the shot image data obtaining part 302 does not produce the shot image data 122 and returns to the initial screen 600 (FIG. 6).

Specific examples of the processes from a display process (step S403) to a superimposition data display process (step S406) will be described next with reference to exemplary screens. FIG. 7 is a diagram depicting the exemplary screens for the processes from the display process to the superimposition data display process.

When the shot image data obtaining part 302 obtains the shot image data 122, the displaying part 305 displays thereon a diagnosis screen 700 depicted in FIG. 7. As depicted in FIG. 7, the diagnosis screen 700 includes a superimposition display area 701, a “reference line designation” button 702, an “edge line designation” button 703, a “superimposition” button 704, and a “return” button 705. Because the designation of the reference lines and that of the edge lines other than the reference lines are not yet accepted at this time point, the “superimposition” button 704 is displayed to be not selectable.

In the diagnosis screen 700, the three-dimensional CAD data 121 that is read and the shot image data 122 that is shot are displayed in the superimposition display area 701.

When the “reference line designation” button 702 is selected in the diagnosis screen 700, designation is enabled for the reference line in the three-dimensional CAD data 121 and the corresponding reference line of the manufactured article included in the shot image data 122. The worker 130 thereby designates the reference line in each of the three-dimensional CAD data 121 and the shot image data 122 that are displayed in the superimposition display area 701. The designating part 304 accepts the one pair of reference lines designated by the worker 130.

The method of designating the reference lines by the worker 130 is optional. The worker 130 may designate the reference lines by designating one point on the reference line or one point in the vicinity of the reference line in the superimposition display area 701, or may designate the reference lines by tracing each of the reference lines therealong. The order of designation for the reference line by the worker 130 is optional. The worker 130 may first designate the reference line in the three-dimensional CAD data 121, or may first designate the reference line of the manufactured article included in the shot image data 122.

When the “edge line designation” button 703 is selected in the diagnosis screen 700, the designation is enabled for the edge lines in the three-dimensional CAD data 121 and the corresponding edge lines of the manufactured article included in the shot image data 122. The worker 130 thereby designates plural corresponding edge lines in the three-dimensional CAD data 121 and the shot image data 122 that are displayed in the superimposition display area 701. Moreover, the designating part 304 accepts the plural pairs of edge lines designated by the worker 130. Similar to the case for the reference lines, the method for the designation and the order for the designation for the edge lines by the worker 130 are each optional.

When the designating part 304 accepts the designation for the reference lines and that for the edge lines other than the reference lines, the displaying part 305 displays thereon a diagnosis screen 710. As depicted in FIG. 7, the diagnosis screen 710 includes a superimposition display area 711, the “reference line designation” button 702, the “edge line designation” button 703, the “superimposition” button 704, and the “return” button 705.

Because the designation for the reference lines and the edge lines other than the reference lines is already executed at this time point, the “superimposition” button 704 is displayed to be selectable in the diagnosis screen 710. When the worker 130 presses down the “superimposition” button 704 in the diagnosis screen 710, the superimposing part 303 executes the superimposition process (whose details will be described later) based on the designated reference lines and the designated edge lines other than the reference lines and thereby produces the superimposition data 123. The superimposition data 123 is thereby displayed in the superimposition display area 711.

When the “return” button 705 is pressed down in the diagnosis screen 700 or 710, the display screen returns to the initial screen 600 (FIG. 6).

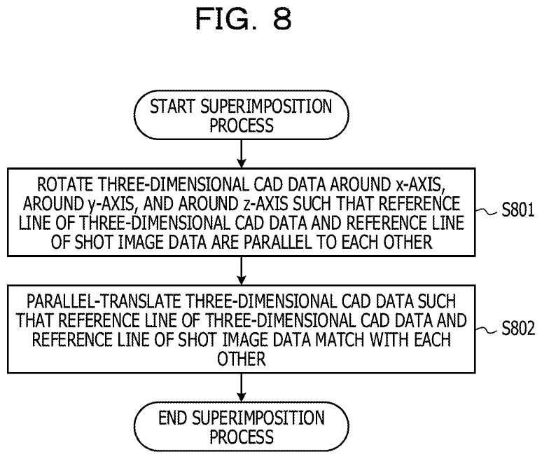

The details of the superimposition process (step S405) of the display control process will be described next. FIG. 8 is a first flowchart depicting the details of the superimposition process.

At step S801, the superimposing part 303 calculates the angles around the x-axis, the y-axis, and the z-axis of the three-dimensional CAD data 121 such that the reference line in the three-dimensional CAD data 121 and the reference line of the manufactured article included in the shot image data 122 become parallel to each other. The superimposing part 303 rotates the three-dimensional CAD data 121 in accordance with the calculated angles.

At this time, the superimposing part 303 calculates the gap amount between the edge lines in the three-dimensional CAD data 121 designated as the edge lines other than the reference line and the corresponding edge lines in the shot image data 122. The superimposing part 303 rotates the three-dimensional CAD data 121 around the reference line in the state where the reference lines are caused to be parallel to each other or to match with each other, such that the calculated gap amount becomes its minimum.

At step S802, the superimposing part 303 calculates the move distance to parallel-translate the three-dimensional CAD data 121 such that the reference line in the three-dimensional CAD data 121 and the reference line in the shot image data 122 match with each other. The superimposing part 303 parallel-translates the three-dimensional CAD data 121 in accordance with the calculated move distance.

As is clear from the above description, in the first embodiment, when the three-dimensional CAD data of a manufactured article is superimposition-displayed on the manufactured article included in the shot image data, one pair of reference lines are designated and the posture of the three-dimensional CAD data is identified in the state where the reference lines are caused to be parallel to each other or to match with each other.

As above, the worker may learn the gap between the edge lines of the manufactured article other than the reference line and the edge lines in the three-dimensional CAD data other than the reference line, as the gap information (the causative point of the gap), by causing the reference lines to match with each other and executing the superimposition-displaying.

As a result, according to the first embodiment, the precision of displaying the gap from the design data of the manufactured article generated by the manufacture of the manufactured article may be improved compared to the case where plural pairs of edge lines are designated and the superimposition-displaying is executed such that the total of the gap amount of the designated pairs of edge lines becomes its minimum.

The case where the one pair of reference lines as the reference line pair is designated has been described in the above first embodiment. In contrast, in the second embodiment, the case where two pairs of reference lines, or one pair of reference lines and one pair of reference points are designated will be described. The second embodiment will be described below mainly for the points that are different from the first embodiment.

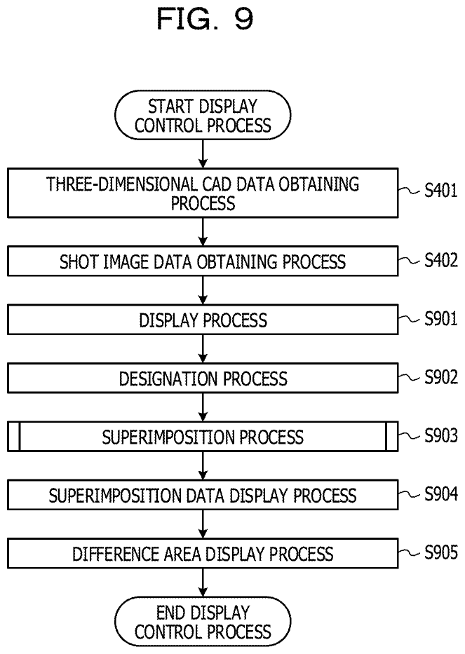

The flow of the display control process executed by the information processing apparatus according to the second embodiment will first be described. FIG. 9 is a flowchart depicting the flow of the display control process executed by the information processing apparatus according to the second embodiment. The different points of this flowchart from the flowchart depicted in FIG. 4 are steps S901 to S905.

At step S901, the superimposing part 303 and the displaying part 305 execute the display process and display the display screen to display therein the three-dimensional CAD data 121 and the shot image data 122.

At step S902, the designating part 304 executes the designation process and accepts designation for the two pairs of reference lines, or the designation for the one pair of reference lines and the one pair of reference points, that are input through the display screen.

At step S903, the superimposing part 303 executes the superimposition process. For example, the superimposing part 303 identifies the posture of the three-dimensional CAD data 121, superimposes the three-dimensional CAD data 121 on the shot image data 122, and thereby produces the superimposition data 123. In identifying the posture of the three-dimensional CAD data, the superimposing part 303 uses the designated two pairs of reference lines, or the designated one pair of reference lines and the designated one pair of reference points.

At step S904, the displaying part 305 executes the superimposition data display process and displays the produced superimposition data 123.

At step S905, the displaying part 305 executes a difference area display process, detects the gap of the edge lines other than the reference lines in the superimposition data 123, and extracts the difference area. The displaying part 305 displays a plane (a two-dimensional figure) to identify the position and the shape of the extracted difference area or a marker identifying the position of the extracted difference area, in a color in accordance with the gap amount (for example, the dimension of the difference area).

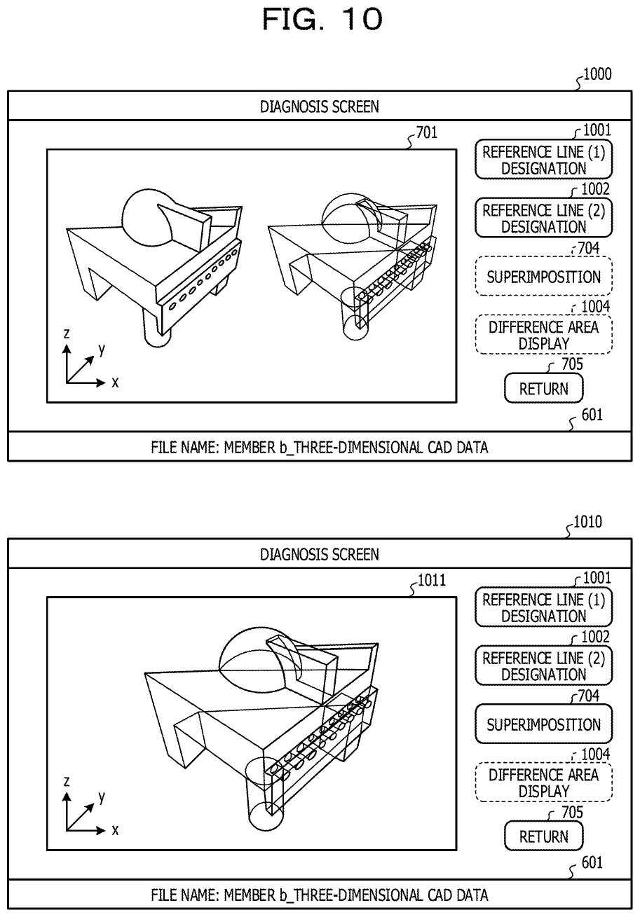

Exemplary screens will be described next for the processes from the display process (step S901) to a difference area display process (step S905) of the processes (steps S401 to S905) of the display control process (FIG. 9). FIG. 10 is a diagram depicting exemplary screens of processes from a display process to a difference area display process.

When the shot image data obtaining part 302 obtains the shot image data 122, the displaying part 305 displays a diagnosis screen 1000 depicted in FIG. 10. As depicted in FIG. 10, the diagnosis screen 1000 includes the superimposition display area 701, a “reference line (1) designation” button 1001, a “reference line (2) designation” button 1002, the “superimposition” button 704, a “difference area display” button 1004, and the “return” button 705. Because no designation for any reference line is accepted at this time point, the “superimposition” button 704 is displayed to be not selectable. Because the superimposition process is not yet executed at this time point, the “difference area display” button 1004 is displayed to be not selectable.

When the “reference line (1) designation” button 1001 is selected in the diagnosis screen 1000, designation is enabled for the first pair of the reference line in the three-dimensional CAD data 121 and the corresponding reference line of the manufactured article included in the shot image data 122.

The worker 130 thereby designates each of the reference lines of the first pair in the three-dimensional CAD data 121 and the shot image data 122 displayed in the superimposition display area 701. The designating part 304 accepts the reference lines of the first pair designated by the worker 130.

When the “reference line (2) designation” button 1002 is selected in the diagnosis screen 1000, designation is enabled for the second pair of the reference line in the three-dimensional CAD data 121 and the corresponding reference line of the manufactured article included in the shot image data 122. Otherwise, designation is enabled for the first pair of the reference point in the three-dimensional CAD data 121 and the corresponding reference point of the manufactured article included in the shot image data 122.

The worker 130 thereby designates each of the reference lines of the second pair in the three-dimensional CAD data 121 and the shot image data 122 displayed in the superimposition display area 701. The designating part 304 accepts the reference lines of the second pair designated by the worker 130.

Otherwise, the worker 130 designates each of the reference points of the first pair in the three-dimensional CAD data 121 and the shot image data 122 displayed in the superimposition display area 701. The designating part 304 accepts the reference points of the first pair designated by the worker 130.

When the designating part 304 accepts the designation for the two pairs of the reference lines, or the one pair of the reference lines and the one pair of the reference points, the displaying part 305 displays thereon a diagnosis screen 1010. As depicted in FIG. 10, the diagnosis screen 1010 includes a superimposition display area 1011, the “reference line (1) designation” button 1001, the “reference line (2) designation” button 1002, the “superimposition” button 704, the “difference area display” button 1004, and the “return” button 705.

The designation is already executed at this time point for the two pairs of the reference lines, or the one pair of the reference lines and the one pair of the reference points, the “superimposition” button 704 is displayed to be selectable in the diagnosis screen 1010. When the “superimposition” button 704 is pressed down by the worker 130 in the diagnosis screen 1010, the superimposing part 303 executes the superimposition process (whose details will be described later) based on the designated two pairs of the reference lines, or the designated one pair of the reference lines and the designated one pair of the reference points, and thereby produces the superimposition data 123. The superimposition data 123 is thereby displayed in the superimposition display area 1011.

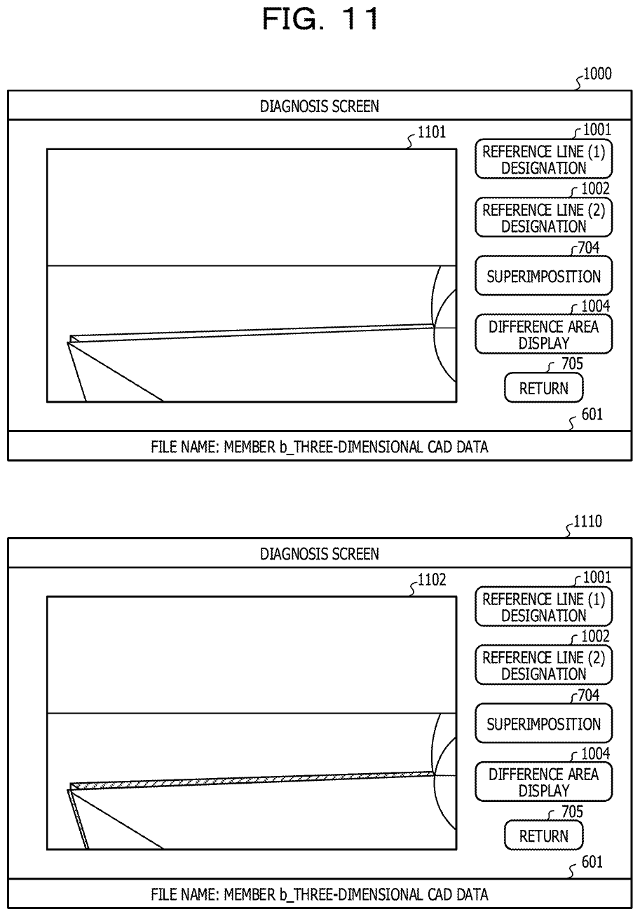

When the “superimposition” button 704 is pressed down and the superimposition data 123 is displayed in the superimposition display area 1011, the display screen advances to a diagnosis screen 1100 in FIG. 11. FIG. 11 is a first diagram depicting an exemplary screen for a difference area display process. As depicted in FIG. 11, the “difference area display” button 1004 is displayed to be selectable in the diagnosis screen 1100.

In a superimposition display area 1101, the worker 130 displays and enlarges the portion that the worker 130 desires to note, of the superimposition data 123 and thereafter presses down the “difference area display” button 1004. The displaying part 305 thereby detects the gap of the edge lines other than the reference lines in the superimposition data 123 and extracts the difference area. In FIG. 11, a diagnosis screen 1110 depicts the state where a two-dimensional figure to identify the position and the shape of the difference area is displayed in the superimposition display area 1102. The displaying part 305, for example, displays the two-dimensional figure in red in the case where the gap amount is large and displays the two-dimensional figure in blue in the case where the gap amount is small.

The worker 130 may easily learn the causative points of the gaps (the point of a manufacture failure) and the degree of the gap amounts, by the fact that the differently colored two-dimensional figures are displayed as above.

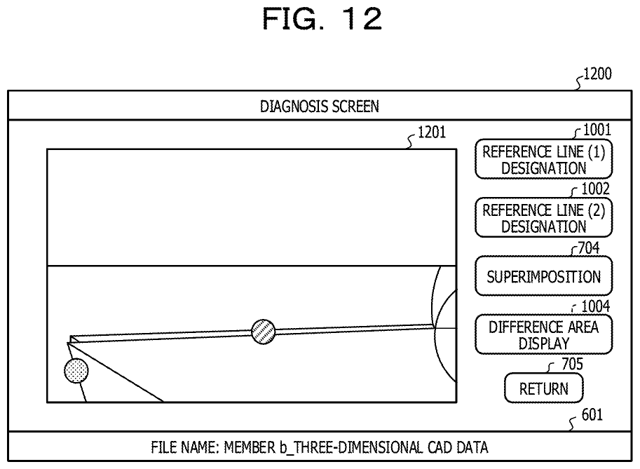

The display method executed by the displaying part 305 for the difference area is not limited to the above. FIG. 12 is a second diagram depicting an exemplary screen for a difference area display process. As depicted in a superimposition display area 1201 of a diagnosis screen 1200 in FIG. 12, the displaying part 305 may display a circular marker that identifies the position of the difference area. It is assumed that the color of the inside of the circular marker is displayed using a color in accordance with the gap amount similarly to the case of the two-dimensional figure.

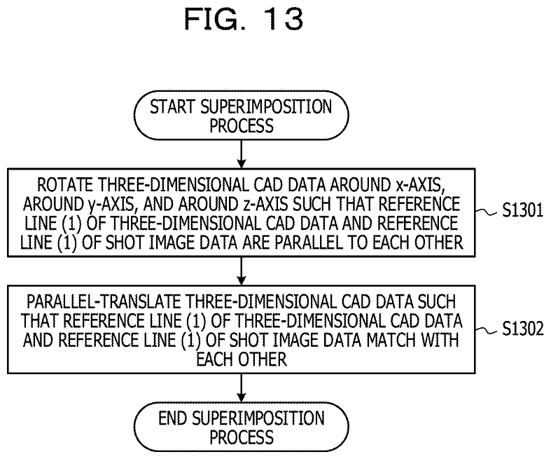

The details of the superimposition process (step S903) of the display control process will be described next. FIG. 13 is a second flowchart depicting details of an imposition process.

At step S1301, the superimposing part 303 calculates the angles around the x-axis, the y-axis, and the z-axis of the three-dimensional CAD data 121 such that the reference line of the first pair included in the three-dimensional CAD data 121 and the reference line of the first pair of the manufactured article included in the shot image data 122 are parallel to each other. The superimposing part 303 rotates the three-dimensional CAD data 121 in accordance with the calculated angles.

At this time, the superimposing part 303 rotates the three-dimensional CAD data 121 around the reference line of the first pair such that the reference line of the second pair in the three-dimensional CAD data 121 and the reference line of the second pair of the manufactured article included in the shot image data 122 match with each other. The superimposing part 303 rotates the three-dimensional CAD data 121 in the state where the reference lines of the first pair are caused to be parallel to each other or to match each other.

Otherwise the superimposing part 303 rotates the three-dimensional CAD data 121 around the reference line of the first pair such that the reference point in the three-dimensional CAD data 121 and the reference point of the manufactured article included in the shot image data 122 match with each other. The superimposing part 303 rotates the three-dimensional CAD data 121 in the state where the reference lines of the first pair are caused to be parallel to each other or to match each other.

At step S1302, the superimposing part 303 calculates the move distance to parallel-translate the three-dimensional CAD data 121 such that the reference line of the first pair in the three-dimensional CAD data 121 and the reference line of the first pair in the shot image data 122 match with each other. The superimposing part 303 parallel-translates the three-dimensional CAD data 121 in accordance with the calculated move distance.

As is clear from the above description, in the second embodiment, when the three-dimensional CAD data of a manufactured article is superimposition-displayed on the manufactured article included in the shot image data, two pairs of reference lines are designated and the posture of the three-dimensional CAD data is identified such that the two pairs of the reference lines match with each other.

Otherwise, in the second embodiment, when the three-dimensional CAD data of a manufactured article is superimposition-displayed on the manufactured article included in the shot image data, one pair of reference lines and one pair of reference points are designated and the posture of the three-dimensional CAD data is identified such that the reference lines match with and the reference points match with each other.

As above, the worker may learn the gap between the edge lines of the manufactured article other than the reference line(s) and the edge lines in the three-dimensional CAD data other than the reference line(s), as the gap information (the causative points for the gaps), by the fact that the reference lines of the two pairs, or the reference lines and the reference points each of the one pair are caused to match with each other and the superimposition-displaying is executed.

As a result, according to the second embodiment, the precision of displaying the gap from the design data of the manufactured article generated by the manufacture of the manufactured article may be improved compared to the case where plural pairs of edge lines are designated and the superimposition-displaying is executed such that the total of the gap amount of the designated pairs of edge lines becomes its minimum.

In each of the first and the second embodiments, the description has been made assuming that the superimposition process (step S405 and step S903) are executed by the information processing apparatus 110. The execution main body is however not limited to the information processing apparatus 110. For example, the execution main body may be a server apparatus that is coupled to the information processing apparatus 110 to be able to communicate therewith.

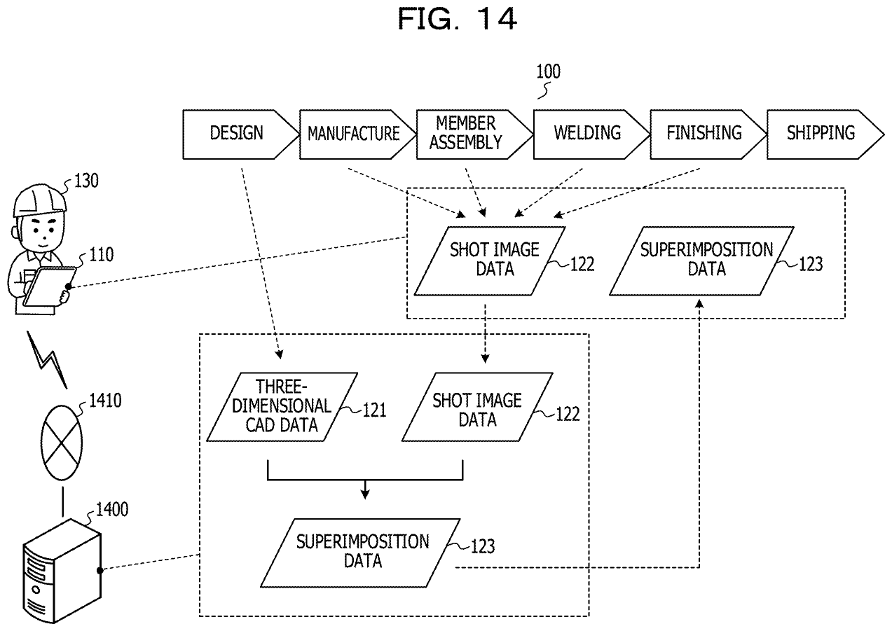

FIG. 14 is a second diagram depicting an application example of a three-dimensional superimposition technique. In the case of the application example depicted in FIG. 14, the information processing apparatus 110 transmits the shot image data 122 shot in each of the processes to a server apparatus 1400 through a network 1410. In the case of the application example depicted in FIG. 14, the information processing apparatus 110 displays the superimposition data 123 transmitted from the server apparatus 1400.

In the case of the application example depicted in FIG. 14, the server apparatus 1400 stores therein the three-dimensional CAD data 121 in advance, superimposes the three-dimensional CAD data 121 in the case where the shot image data 122 is transmitted from the information processing apparatus 110, and thereby produces the superimposition data 123. In the case of the application example in FIG. 14, the server apparatus 1400 transmits the produced superimposition data 123 to the information processing apparatus 110 through the network 1410.

As above, the server apparatus 1400 may provide a superimposition display service to various manufacturers, by executing the superimposition process by the server apparatus 1400.

In the above first embodiment, the description has been made assuming that the worker 130 selects the “reference line designation” button 702 and the “edge line designation” button 703, and thereafter designates the reference lines and the edge lines other than the reference lines. The selection method for the reference lines by the worker 130 is however not limited to the above and, for example, plural edge line pairs may first be designated and a reference line pair may be selected from the designated plural edge line pairs.

In the above first embodiment, the description has been made assuming that the worker 130 designates the edge lines other than the reference lines. The worker 130 may however designate the edge lines other than the reference line of the manufactured article included in the shot image data 122 and the designating part 304 may automatically correlate the edge lines other than the reference line in the three-dimensional CAD data 121. Otherwise, for example, the superimposing part 303 automatically selects the edge lines other than the reference line from each of the three-dimensional CAD data 121 and the shot image data 122 and may correlate these with each other.

In the above first to the above third embodiment, the description has been made assuming that the worker 130 designates the reference line of the manufactured article included in the shot image data 122 and the reference line in the three-dimensional CAD data 121 and these two are thereby correlated with each other. The worker however may designate the reference line of the manufactured article included in the shot image data 122 and the designating part 304 may automatically correlate (execute paring of) the reference line in the three-dimensional CAD data 121 based on the designated reference line of the manufactured article. In this case, the designating part 304 functions as a paring part.

In the above first embodiment to the above third embodiment, the description has been made assuming that, when the superimposition process is executed, the posture of the three-dimensional CAD data 121 is identified in the state where the reference lines are caused to be parallel to each other or to match with each other. The reference lines used in the case where these reference lines are caused to match with each other when the superimposition process is executed, may however not completely match with each other. For example, the posture of the three-dimensional CAD data 121 may also be identified in the state where the degree of the matching of the reference lines with each other is equal to or higher than a given matching degree.

In the above first embodiment to the above third embodiment, lines extracted from the manufactured article included in the shot image are each referred to as “edge line” and the lines included in the three-dimensional CAD data are each referred to as “ridge line” and, for the convenience of the description, both of these are thereafter handles as “edge lines.” The names of these lines used for the superimposition display are optional. For example, the edge lines extracted from the manufactured articles included in the shot images include edge lines that correspond to the ridge lines of the manufactured articles. The designation of the edge lines may be regarded as that corresponding to the designation for the ridge lines.

In the above first embodiment to the above third embodiment, the description has been made assuming that the size of the manufactured article included in the shot image data 122 and the size of the three-dimensional CAD data 121 correspond to each other when the superimposition process is executed. The size of the three-dimensional CAD data 121 may however be processed to be increased or reduced when the superimposition process is executed.

The present invention is not limited to the configurations presented herein, and any combination of any of the configurations listed in the above embodiments and any other element, and the like may be employed. Changes may be made concerning these points within the scope not departing from the gist of the present invention and these changes may properly be determined in accordance with the application forms thereof.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A computer-implemented display control method comprising:
displaying a first plurality of edge lines extracted from an image that includes a manufactured article;
accepting designation for a second plurality of edge lines selected from the displayed first plurality of edge lines;
identifying pairs each of which includes an edge line of the second plurality of edge lines and a line of a plurality of lines corresponding to the edge line, the plurality of lines being included in a three-dimensional model described based on design data of the manufactured article;
determining a specific display posture of the three-dimensional model such that a positional relation between a first edge line and a first line included in a first pair satisfies a condition and a position of a second edge line and a position of a second line included in a second pair correspond to each other; and
superimposing, in accordance with the specific display posture, the three-dimensional model on the image.

2. The display control method according to claim 1, wherein
the identifying includes accepting designation for the first plurality of lines.

3. The display control method according to claim 1, wherein
the first edge line of the first pair is an edge line at a position corresponding to a reference line used when the manufactured article is manufactured.

4. The display control method according to claim 3, wherein
the second edge line of the second pair is an edge line at a position corresponding to another reference line used when the manufactured article is manufactured or an edge line at a position corresponding to a reference point used when the manufactured article is manufactured.

5. The display control method according to claim 1, wherein
the superimposing includes displaying a figure representing at least one of a position and a shape of a difference between the position of the second edge line and the position of the second line.

6. The display control method according to claim 5, wherein
a color of the figure is determined in accordance with a dimension of the difference.

7. A display control apparatus comprising:
a memory; and
a processor coupled to the memory and the processor configured to
display a first plurality of edge lines extracted from an image that includes a manufactured article,
accept designation for a second plurality of edge lines selected from the displayed first plurality of edge lines,
perform identification of pairs each of which includes an edge line of the second plurality of edge lines and a line of a plurality of lines corresponding to the edge line, the plurality of lines being included in a three-dimensional model described based on design data of the manufactured article,
perform determination of a specific display posture of the three-dimensional model such that a positional relation between a first edge line and a first line included in a first pair satisfies a condition and a position of a second edge line and a position of a second line included in a second pair correspond to each other, and
perform superimposition of the three-dimensional model on the image in accordance with the specific display posture.

8. The display control apparatus according to claim 7, wherein
the identification includes accepting designation for the first plurality of lines.

9. The display control apparatus according to claim 7, wherein
the first edge line of the first pair is an edge line at a position corresponding to a reference line used when the manufactured article is manufactured.

10. The display control apparatus according to claim 9, wherein
the second edge line of the second pair is an edge line at a position corresponding to another reference line used when the manufactured article is manufactured or an edge line at a position corresponding to a reference point used when the manufactured article is manufactured.

11. The display control apparatus according to claim 7, wherein
the superimposition includes displaying a figure representing at least one of a position and a shape of a difference between the position of the second edge line and the position of the second line.

12. The display control apparatus according to claim 11, wherein
a color of the figure is determined in accordance with a dimension of the difference.

13. A non-transitory computer-readable medium storing instructions executable by one or more computers, the instructions comprising:
one or more instructions for displaying a first plurality of edge lines extracted from an image that includes a manufactured article;
one or more instructions for accepting designation for a second plurality of edge lines selected from the displayed first plurality of edge lines;
one or more instructions for identifying pairs each of which includes an edge line of the second plurality of edge lines and a line of a plurality of lines corresponding to the edge line, the plurality of lines being included in a three-dimensional model described based on design data of the manufactured article;
one or more instructions for determining a specific display posture of the three-dimensional model such that a positional relation between a first edge line and a first line included in a first pair satisfies a condition and a position of a second edge line and a position of a second line included in a second pair correspond to each other; and
one or more instructions for superimposing, in accordance with the specific display posture, the three-dimensional model on the image.
